(19) United States
(12) Patent Application Publication
(10) Pub. No.: US 2004/0011378 A1
(43) Pub. Date: Jan. 22, 2004

(54) Surface cleaning and modification processes, methods and apparatus using physicochemically modified dense fluid sprays

(76) Inventor: David P Jackson, Saugus, CA (US)

Correspondence Address: Sonnenschein Nath & Rosenthal, 601 Figueroa Ste 1500, Los Angeles, CA, 90017-5720, US

(21) Appl. No.: 10/362,598

(22) PCT Filed: Aug. 23, 2001
(86) PCT No.: PCT/US01/26546

(51) Int. Cl. B08B 3/12

(52) U.S. Cl. 134/1; 134/1.2; 134/1.3

(57) ABSTRACT

The present invention relates generally to providing processes, methods and apparatus to produce and apply a variety of surface cleaning and modification spray treatments. More specifically, the present invention provides the simultaneous steps of 1) selectively removing one or more unwanted surface contaminants, including extremely hard coatings, 2) exposing a native clean surface layer and 3) modifying said exposed and cleaned native substrate surface layer to energetic radicals and radiation to improve adhesion, wettability or coatability. Reactive species in combination with non-reactive, but chemically or physically active, species provide a rich reaction control and surface treatment environment by which contaminants and surface interlayers are oxidatively, physically and/or chemically removed or modified to prepare an underlying substrate surface for subsequent bonding, deposition, coating and curing operations. Substrates treated in accordance with the present invention have cleaner and higher surface free energy surfaces.

### BACKGROUND

The present invention relates in general to a cleaning spray system which employs a solid carbon dioxide (snow) spray mixture stream, physicochemically modified to contain reactive inorganic gaseous species, which is directed at variable velocity, spray temperatures, and pressures onto substrate surfaces of components or articles that require cleaning and substrate treatment to allow for better bonding, gluing, markability, paintability, coatability or pottability. Various embodiments are incorporated herein which enhance the utility of the present invention.

The joining or bonding of substrates is a surface phenomenon, therefore surface preparation prior to bonding is critical for successful bonding. The sole purpose of surface preparation is to attain adherend surfaces receptive to the development of strong, durable bonded joints. It is desirable to have the basic adherend material (clean native substrate surface) exposed directly to the bonding agent (i.e., adhesive), coating agent (i.e., thin film), soldering agent (i.e., molten solder) or, in the case of acoustic: welding, a second clean and treated adherend. The absence of a second intervening layer such as an oxide film, particle, coating or release agent is often desirable. Conventional surface preparation processes for bonding typically involves two separate substrate surface treatments as follows: 1) surface cleaning to remove gross or trace surface contamination such as old coatings and paint and/or thin film hydrocarbons and particulates, and 2 surface modification to increase surface free energy (wetting) to promote contact between newly applied bonding agents and adherends. Achieving adequate adhesion to polymeric (organic), ceramic, glass and metallic (inorganic) adherends is a recurring and difficult problem throughout many industries. Many cleaning and modification processes have been developed and are discussed below.

Historically, various surface treatments have been used to improve the adhesion of coating or bonding agents to plastics. These include flame treatment, mechanical abrasion, solvent cleaning or swelling followed by wet chemical etching, or the application of specialized coatings in the form of chemical primers. Often what works for one specific application will not be effective for another, thus specific treatments need to be developed for each. For example, flame surface treatments present fire hazards and may damage heat-sensitive substrates. Solvent cleaning employing hazardous organic solvents such as acetone, toluene and methyl ethyl ketone (MEK) and acid or alkaline etching solutions present flammability, operator safety and/or ecological hazards, or may damage the substrate. Mechanical abrasion creates a particle aid residue clean-up issue and may damage critical surface topography. Moreover, the use of chemical primers requires specialized formulations for each type of polymer substrate.

Ceramics, pyroceramics and glasses are scrubbed with Ajax cleanser, or equivalent abrasive cleaner, rinsed with deionized or distilled water and dried at 120 to 150 F. Metallic substrates may be solvent cleaned using xylene, methyl ethyl ketone (MEK), or isopropyl alcohol (IPA) and air dried. Bare copper alloys are typically vapor degreased to remove gross soils, dipped in a nitric acid/ferric chloride solution to remove metallic oxides, rinsed with tap water to remove cleaning agents, spray rinsed with deionized water and finally air dried at 120 to 150 F. Alternatively, bare copper may be abrasively blasted with silica particles to remove metallic oxides, rinsed with deionized water to remove abrasives, and air dried at 120 to 150 F. Fluorinated polymers are wiped with acetone to remove gross surface contaminants, treated with sodium-napthalene solution, rinsed with acetone rinsed with deionized water to remove acetone residues and air dried at 100 F. Other common substrate treatment solutions include an FPL etch, which is a sulfuric aciddichromate pickling solution, and alkaline treatments such as sodium hydroxide-ferricyanide solutions. With some polymeric substrates, an extended strong organic solvent soak is necessary to produce a high energy surface layer which can be wetted by an adhesive or coating.

Consistent surface modification requires, in most cases, a fairly clean substrate—free of gross hydrocarbon contaminants and monolayers present on the uppermost surface layers. However, this requires performing a cleaning step independent of and prior to surface treatment. For example, solvent cleaning is acceptable for cleaning most substrates free of organic contaminants but has limited utility where a distinct change in the chemical nature of the substrate surface is required.

Where chemical treatments cannot be used due to part geometry, sensitivity or compatibility, and/or environmental risk, plasma etch techniques may be employed. However, a typical pretreatment prior to plasma etch is to remove oil, grease and other surface contaminants using an organic solvent such as 1,1,1 trichloroethane, toluene or MEK. Following this, the substrate is exposed to a gas plasma for 5 to 10 minutes at between 1 and 10 watts/cu.in. and under atmospheres of between 1 to 2 torr comprising oxygen, argon or water vapor and mixtures thereof.

Moreover, sand blasting, sand paper, abrasive pads or other mechanical abrasion techniques may be employed in place of chemical treatments. Similar to plasma etch treatments discussed above, the substrate must be degreased prior to mechanical abrasion, and following treatment, the residual abrasive agents must be removed from the surface. As such, multiple and separate steps are required to clean and prepare a substrate surface for bonding operations. Although, mechanical abrasion will remove hardened surface layers such as old polymeric coatings, paint, adhesives and metal oxides, it may not necessarily adequately treat the underlying exposed substrate surface. For example, activated plasma treatments discussed above using oxygen argon or water vapor plasma have demonstrated bond strengths three to four times that of abrasive surface preparation techniques. As such, both of these surface cleaning and treatment methods may have to be used in sequential order to properly clean and modify a surface in preparation for bonding.

For example, a typical substrate surface cleaning and modification application is the removal of old conformal coatings, for example parylene (an organic polymeric coating used to hermetically seal an electronic package), to enable the replacement of an electrical component mounted on an electronic substrate (i.e., BGA de-soldering, replacement and resoldering operation). In this common rework application, the parylene coating covering the BGA is selectively stripped using a chemical or abrasive agent. Following this, the BGA is de-soldered from the surface, the surface is cleaned and modified to promote wetting by solder and new conformal coating. A replacement component is re-soldered, and a new coating of parylene is applied and cured. This is exemplary of commercial production practices that require the iterative steps of stripping, cleaning, and modification.

More energetic, ecologically-friendly and worker-safe alternatives have been developed. These include, high energy density treatments such as ultraviolet (UV) radiation (with/without ozone) and atmospheric plasma have gained greater acceptance on a larger scale for substrate surface modification. They provide a medium rich in reactive species, such as energetic photons, electrons, free radicals, and ions, which, in turn, interact with the polymer or metallic substrate surface, changing its surface chemistry and/or morphology. However, these newer processes require that the substrate be free of gross contamination, wherein some type of conventional surface cleaning process is still required prior to use of these high energy surface modification processes. One example of a conventional surface modification system is the PT-2000 Plasma Treatment System from Tri-Star Technologies, El Segundo, Calif. The device uses a supply of nitrogen, argon, oxygen and/or other gases, singularly or in combination, in combination with an electrical corona generator and suitable corona forming nozzles to create a gas jet plasma or atmospheric plasma stream. The atmospheric plasma stream is then directed at a substrate thereby modifying its surface—creating high surface free energy and implanting functional groups into the surface layers, depending upon the plasma gas phase chemistry used. Different plasma gases and gas mixtures provide different surface properties. As such, the desired surface treatment can often be optimized for a particular surface, and bonding process. Recommended pre-cleaning of the surface is either a solvent wipe or aqueous wash and dry.

An example of an energetic surface cleaning and modification technique is given in U.S. Pat. No. 5,054,421, Ito, et al. In this process, a substrate is cleaned using a gas jet which is simultaneously irradiated with an electron beam. The gas molecule are excited through the creation of a glow discharge (plasma), following which the reactive gas mixture is contacted with the substrate. A voltage of up to 2000 volts may be applied between two electrodes to produce the glow discharge. The process is performed under a depressurized condition, 0.1 to 10 mm Hg vacuum, and elevated temperatures using various inorganic and organic gases and mixtures, for example silane and oxygen. An electric field imparts momentum and accelerates the reactive gas mixture, under vacuum, at the substrate surface. The '421 process teaches both cleaning and coating the substrate with thin films (i.e., silicon) using the invention. The process as taught is performed under low pressure conditions to impart ionization to the cleaning gases (i.e., oxygen—O₂) or thin film forming gas (i.e., silane—SiH₄). The main drawbacks with this invention as it relates to surface cleaning and treatment is that it must be performed within a vacuum environment, necessitating the use of expensive vacuum chambers, pumps and environmental controls. As with most conventional vacuum plasma cleaning processes, the substrate surface must be significantly absent of gross hydrocarbon contaminants to prevent the contamination of the vacuum environment and to allow the reactive gases to contact the underlying substrate surface.

From the above, it can be seen that a method and apparatus for cleaning and treating various medical, electronic and mechanical substrates that offers enhanced cleaning and surface modification under standard temperature and pressure conditions, and is safe, easy, and reliable and can be easily integrated with automation and control systems for inline production applications is often desired. Moreover, it is desirable to have a process, method and apparatus that can be integrated with conventional bonding agents and/or processes to allow for in-situ surface cleaning and modification with bonding, coating, painting and curing. As such, there is a present need to provide processes, methods and apparatus for simultaneously cleaning and modifying a substrate surface in preparation for bonding, gluing, marking, painting, coating, potting and curing.

### SUMMARY OF THE INVENTION

The present invention overcomes the deficiencies of prior art cleaning systems by providing processes, methods and apparatus for simultaneous cleaning and treating a substrate surface, irrespective of the initial and in-process substrate surface and particulate contamination levels. Moreover, the present invention can be applied under atmospheric or greater pressure and temperature conditions to a variety of substrates having complex topography. The present invention was developed to prepare a variety of substrates for structural joining—for example adhesive bonding, TIG/MIG/Acoustic welding, soldering, painting and/or coating and curing. However, it may be used for any number of substrate treatments requiring a high degree of cleanliness and/or high surface energy, for example, cleaning and sterilizing medical device substrate surfaces such as syringe needles and bodies, catheters, pacemakers and the like.

In summary, the present invention provides a variety of processes, methods and apparatus for providing a variety of cleaning and modification spray treatments. The present invention provides the simultaneous steps of 1) selectively removing one or more unwanted surface contaminants, including extremely hard coatings, 2) exposing a native clean surface layer and 3) modifying said exposed and cleaned native substrate surface layer to energetic radicals and radiation to improve adhesion, wettability or coatability. Reactive species in combination with non-reactive, but chemically or physically active, species provide a rich reaction control environment by which contaminants and surface layers are oxidatively, physically and chemically destroyed and entrained to prepare the substrate surface for subsequent bonding, deposition, coating and curing operations. Substrates treated in accordance with the present invention have clearer and higher surface free energy surfaces.

Embodiments of the present invention disclosed herein include, but are not limited to, the following:

Creating a combination of reactive oxidative or reductive species (reactive gases and by-product radiation) and non-reactive species (solid particles) in a composite surface cleaning and modification stream;

Providing a mechanism for simultaneously removing gross coating, particle, ionic, inorganic and organic contamination layers contained on the uppermost layers of a substrate surface, exposing the resulting contaminant-free substrate interlayers to reactive species and by-product ultraviolet radiation, continuously removing interlayer reaction by-products during continuous contact and providing environmental control within the reaction zone to optimize the reaction;

Providing a continuous source of cleaning energy (pressure shear, heat, reactants) within the propellant stream to enhance contaminant separation, reaction and in-situ localized environmental control;

Providing in-situ reactive species such as ozonated snow chemistry to greatly enhance contaminant-contaminant and contaminant-substrate bond destruction through pressure-enhanced oxidation;

Providing in-situ reaction heat dissipation using solid carbon dioxide sublimation energy;

Providing a method and apparatus for mixing small amounts of various microabrasives, some having static dissipative characteristics, into the propellant stream and mixed with snow particles to remove physically hard substrate surface layers such as polymeric coatings and metal oxide layers, and simultaneously using snow particles to remove said microabrasive and ablated coating particles; and

Providing design and operational characteristics that allow for automation and control of the present cleaning processes and integration with production tools such as surface inspection devices and adhesive dispensers, utilizing the present inventions in-situ UV curing embodiment.

### BRIEF DESCRIPTION OF THE DRAWINGS

The features and advantages of the present invention will become apparent from the following detailed description of a preferred embodiment thereof, taken in conjunction with the accompanying drawings in which:

FIG. 1 is a schematic diagram of the exemplary dense fluid spray surface cleaning and modification process.

FIG. 2 is a schematic diagram of the exemplary dense fluid plasma nozzle.

FIG. 3 is a schematic diagram of the exemplary dense fluid plasma generation.

FIG. 4 is a schematic diagram of the exemplary dense fluid plasma spray system.

FIG. 5 is a schematic diagram of the exemplary dense fluid plasma spray extraction system.

FIG. 6 is a schematic diagram of the exemplary dense fluid-ozone generation and application system using corona plasma.

FIG. 7 is a schematic diagram of the exemplary dense fluid-ozone generation and application system using ultraviolet radiation.

FIG. 8 is a schematic diagram of the exemplary dense fluid-microabrasive generation and application system.

FIG. 9a is a schematic diagram of the exemplary alternative dense fluid surface cleaning and modification using a conventional corona plasma treatment device in combination with a dense fluid spray.

FIG. 9b is a schematic diagram of the exemplary alternative dense fluid surface cleaning and modification using a conventional pulsed ultraviolet curing device in combination with a dense fluid spray.

FIG. 9c is a schematic diagram of the exemplary alternative dense fluid surface cleaning and modification using conventional microabrasive surface treatment device in combination with a dense fluid spray.

### DETAILED DESCRIPTION OF THE PREFERRED EMBODIMENTS

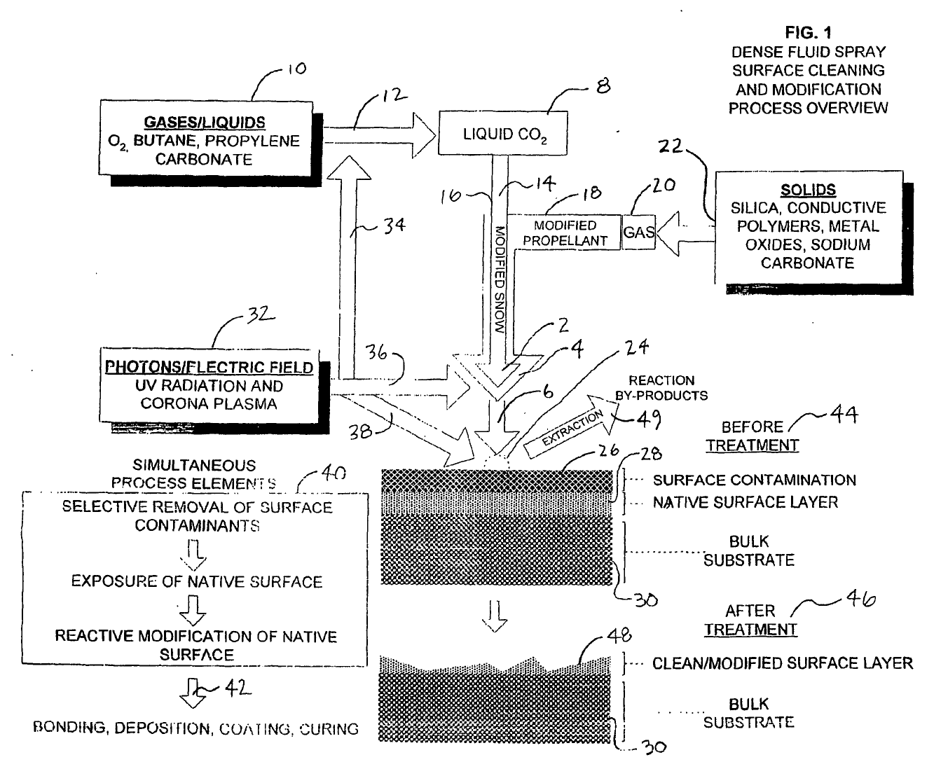

Turning now to a more detailed consideration of the preferred embodiments of the present invention, FIG. 1 illustrates a schematic diagram of the exemplary dense fluid spray surface cleaning and modification process. Referring to FIG. 1, the present invention employs three cleaning and modification streams as follows: 1) a modified solid carbon dioxide (snow) spray stream (2) and/or 2) a modified snow propellant (TIC—thermal inert gas) stream (4) and/or 3) a modified TIG-Snow dense fluid cleaning and modification spray stream (6).

A modified snow spray stream (2) is generated as follows. Using a source of liquid carbon dioxide (8) which is physicochemically modified with various organic and/or inorganic gases or liquids (10), and mixtures thereof, including but not limited to, oxygen gas, n-butane gas, propylene carbonate liquid via injection (12) of said modifiers into said liquid carbon dioxide (8). Following this, the liquid carbon dioxide is condensed into a solid using an enhanced condensation process (14) developed by the present inventor, and discussed in detail in a pending patent application, thereby forming a dense solid carbon dioxide particle mixture encapsulating said modifiers in the form of solid-gas and/or solid-liquid matrices. The modified snow stream (2) is transported via a polymeric or metallic capillary tube (16) and into a coaxial assembly tube (18), which contains a modified snow propellant stream (4). The modified snow propellant stream (4) is generated as follows.

A source of propellant gas (20), which may include but is not limited to, oxygen, nitrogen, argon, helium, carbon dioxide, clean-dry-air and/or water vapor, and mixtures thereof, is optionally modified through the addition of a source of solid micro abrasive additive (22), which may include but is not limited to fine silica, conductive polymers, metal oxide, and/or sodium carbonate particles. The modified propellant stream (4) is fed coaxially with the modified snow stream (2), contained within a capillary feed tube (16), through an outer coaxial tube (18). An apparatus for coaxially delivering, mixing and propelling said modified mixtures is described in U.S. Pat. No. 5,725,154, as well as described in a pending patent application, both by the present inventor.

The modified snow stream (2) and modified snow propellant stream (4) are mixed in a convergent-divergent nozzle assembly (not shown) to produce a modified and variable geometry (pressure, temperature and modifier concentration control) TIG-Snow surface cleaning and modifying spray stream (6). The modified TIG-Snow spray stream (6) is directed at a portion of a substrate, called the reaction site (24) herein, comprising the layers of 1) surface contamination (26), 2) native substrate surface layer (28) and bulk substrate (30). The temperature of the mixture is adjusted by adjusting the temperature of the propellant stream (4) using an in-line heater (not shown) and the pressure of the mixture is adjusted by adjusting the propellant stream (4) pressure using a pressure control gage (not shown). Temperature and pressure control features of the present invention are described in detail in the referenced '154 invention and pending patent above.

The modified snow stream (2) and/or propellant stream (4) and/or TIG-Snow cleaning and modification stream (6) may be further modified using ultraviolet radiation and/or corona plasma (32) to produce reactive modifying agents or species to be contained therein. Reactive modifying agents used in the present invention comprise excited atomic, molecular, ionic and radical species—generated through the interaction of the entrained modifying constituents with an electric field, corona discharge or ultraviolet radiation. For example, an applied electric field having a field strength of between 5,000 and 25,000 volts as generated within an exemplary plasma spray nozzle, described in more detail later in this specification, to produce reactive species within the snow or propellant streams through the formation of a corona plasma. The corona treatment may be applied (34) to the liquid carbon dioxide modifiers (10), for example oxygen gas, to produce ozone as an additive injection into liquid carbon dioxide (8). The ozone is entrained within the condensed liquid carbon dioxide as a snow-ozone chemistry. In another example, a corona treatment may be applied (36) to the coaxial mixture of modified TICS-Snow spray mixture (6) containing argon and oxygen gases to produce a mixture of snow, ozone and excited argon radicals. Finally, the corona plasma may be applied (38) to the reaction site (24), and specifically the surface contamination layer (26) and native surface layer (28) in combination with the souring cleaning action of the impinging snow particles and modified propellant streams. Using this approach, a mixture of corona plasma, excited radicals, and impinging cleaning particles are produced at the reaction site (24)—providing a very aggressive surface cleaning and modification enhancement.

Similarly, ultraviolet radiation may be applied as described above in place of or in combination with corona plasma to produce reactive species within the snow, propellant or reaction site. An exemplary ultraviolet radiation device used in the present invention is a pulsed ultraviolet radiation source, delivered from a xenon gas lamp via a light pipe and coupled with the spray streams, and having an energy output of between 1 and 3 joules/pulse at rate of between 100 and 150 pulses/second. Using this device, a UV rich spectrum of wavelengths can be produced in a single burst—from 100 to 400 nm and up to 200 watts/cm². Ozone modifier is readily generated when oxygen is present within the liquid, solid and/or gas stream constituents of the present invention using high output within the 189.9 nm region of the radiation. The ultraviolet radiation embodiment has advantages over corona plasma treatment in applications where the substrate may be damaged by a direct corona plasma treatment (38) due to electrostatic discharge concerns. Also, in integrated cleaning, modifying and bonding applications of the present invention the ultraviolet radiation embodiment is used as an curing tool for a UV-curable coating, potting or adhesive bead that has been applied to the cleaned and treated substrata.

Following is an overview of the dense fluid spray cleaning and modification process itself. The process thus described comprises the following elements:

1. Physicochemical modification of a snow stream (2) using gases, liquids, UV radiation and/or corona plasma treatment an enhanced condensation reaction.

2. Physicochemical modification of a propellant (TIG) stream (4) using various gases and solids (microabrasives).

3. Physicochemical modification of a TIG-Snow cleaning and modification spray stream (6) using pressure and temperature control, corona plasma treatment, and/or ultraviolet radiation.

4. Physicochemical modification of the cleaning spray-substrate surface reaction site or interface (24) using pressure and temperature control, corona plasma and ultraviolet radiation treatment.

Moreover, the TIG-Snow cleaning and modification stream (6) and reaction site (24) have the following physicochemical make-up:

1. Oxidative species—ozone and excited molecular, atomic, ionic radical species

2. Photons—ultraviolet radiation applied directly to substrate or applied indirectly as a by-product of corona plasma ion re association reactions.

3. Physical species—solid carbon dioxide particles provides chemical cleaning and scouring action, entrain and deliver modifiers, and cool plasma and UV reactions at reaction site. Microabrasives provide aggressive ablative cleaning action.

4. Temperature control—temperature of propellant stream may be adjusted from, for example, between 20 to 150 C.

5. Pressure control—pressure of impinging cleaning and modification spray be adjusted from, example, between 20 to 3000 psi.

6. Environmental control—modified propellant provides an artificial and reaction-enhancing environment, thereby excluding ambient atmosphere containing contaminating moisture and gases from reaction site.

The present invention provides a variety of processes, methods and apparatus for engineering a variety of cleaning and modification (treatment) sprays—providing the simultaneous steps as shown in process description block (40) of 1) selectively removing one or more unwanted surface contaminants, including extremely hard coatings, 2) exposing a native clean surface layer and 3) modifying said exposed and cleaned native substrate surface layer to energetic radicals and radiation to improve adhesion, wettability or coatability. Reactive species in combination with non-reactive, but chemically or physically active, species provide a rich reaction control environment through which contaminants and surface layers are oxidatively, physically and chemically destroyed and entrained to prepare the substrate surface for subsequent bonding, deposition, coating and curing operations (42). As a result, before treatment (44) substrate interlayer chemistry differs markedly from after treatment (46) interlayer chemistry using the processes, methods and apparatus of the present invention. These include a much cleaner and higher surface free energy substrate surface (48).

Finally, reaction by-products of the present invention include various admixture gases and solids such as residual ozone gas, carbon dioxide, nitrogen, water vapor, and microabrasive particulates. These by-products may be extracted from the reaction site (24) under a vacuum exhaust stream (49) using a fume extraction hood (not shown) or novel integrated treatment and extraction nozzle designs of the present invention and described below. The extracted by-products may be further treated to destroy residual ozone and remove particle matter from the waste stream prior to discharge into the environment. The use of solid modifiers in the present invention is performed in a sequential or pulsed manner so that following admixturing and application, snow particles are used to remove residual microabrasives and ablated surface contamination and are then extracted from the reaction site as described above.

Turning to a discussion of the various and novel reaction kinetics and chemistries associated with the present invention. The addition of certain gaseous modifiers such as nitrogen gas, water vapor into the propellant stream and exposing said modified stream to high energy plasma or radiation produce, as a by-product, beneficial functional groups (i.e. —N, —OH) which are chemically bonded to the clean/modified substrate surface layers (48) which promote adhesion strength during subsequent bonding processes. Moreover, UV radiation is a by-product of corona plasma treatment through the re-association of electrically excited ions—emitting energetic photon energy during electron decay. UV radiation promotes new radical formation within the treatment streams, at the reaction site and reacts directly with organic surface contamination—breaking the contamination into more soluble or volatile species. The choice of solid modifiers is also important—a particular microabrasive is selected that when propelled at the reaction site, provides enough kinetic energy to selectively abate the contain nation (i.e., epoxy). The presence of reactive particles within the TIG-Snow stream greatly increases energy content, and resulting effect upon surface contamination and native surface layer. It is estimated that reactive particle densities within a corona plasma range from 1×10¹⁰ to 1×10¹² reactive particles per cubic centimeter of reaction gas and reactive particle-substrate reaction interphase temperatures range from 1-3 ×10³ Kelvin, similar to acoustic surface cleaning phenomenon. It is believed that both high reactive species densities and intermolecular reaction temperatures of plasmas play the predominant role in surface treatment—a form of micro molecular oxidation and ablation. Delivery of these concentrated reactive species to the substrate, and specifically to a portion of a substrate, before they decay is imperative—the present invention utilizes a supersonic delivery and targeting means to optimize and control delivery of reactive species. The reactive dense fluid sprays of they present invention are directional and selective—providing both macro and micro molecular level surface cleaning and modification effects.

Moreover, snow particles used herein operate as an active surface cleaning agent, a modifier delivery vehicle (i.e., snow-ozone) and a cooling agent. Solid phase carbon dioxide is an excellent thin film hydrocarbon removal agent due to its dispersion chemistry and lyophilic behavior (Solubility Parameter—22 MPa^{1/2}), similar to 1,1,1 trichloroethane. Adding compounds such as propylene carbonate and n-butane will greatly improve the solvency for various surface contaminants not easily solubilized in solid carbon dioxide alone. Also, chemical agent modifiers may be chosen which alter the tribocharging properties of solid phase carbon dioxide—thereby reducing or eliminating tribocharging phenomenon during contact with substrate surfaces. Moreover, incorporating an oxidative chemical such as ozone into the snow matrix provides a powerful cleaning agent combination —both chemical and oxidative cleaning actions. Moreover, dense solid carbon dioxide particles containing ozone impact a substrate at near-sonic or supersonic velocities—the kinetic energy imparted at the substrate surface-cleaning agent interface can be extremely large. It is possible to have the ozone phase contained within the solid carbon dioxide matrix (Snow Particle Temperature is −80 C) to be compressed to above its liquefaction point, or at least heavily concentrated beyond normal atmospheric ozone gas treatments. This concentrated chemistry is driven into the solid phase matrix. This ‘concentration effect’, under great pressure, significantly enhances the reaction kinetics for ozone oxidation reactions and solubility-extraction of interphasic contaminants.

The present invention provides a variable-geometry spray, the constituents of which work in union, to selectively and simultaneously remove surface contamination and modify the underlying expose surface layers. For example snow particles removing lower molecular weight surface layers, microabrasives removing highly crystalline coatings and reactive species modifying exposed and clean surface layers.

Finally with respect to reaction site cooling, substrate cooling is enabled during application of corona plasma or UV radiation through sublimation heat extraction—preventing thermal damage to delicate substrates. Having thus described the process elements of the present invention, the following is a more detailed description of various apparatus used to practice the invention thus disclosed.

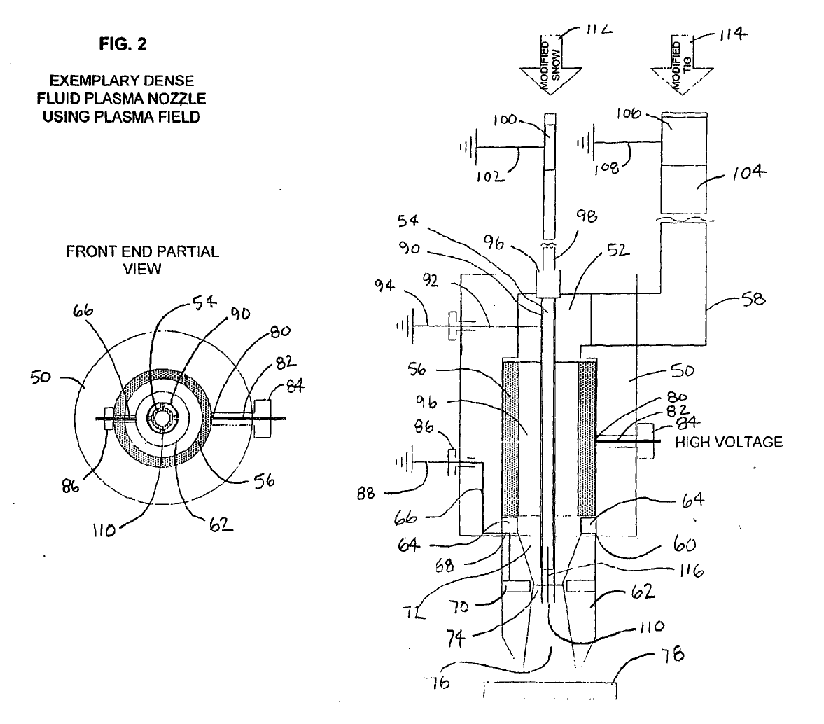

FIG. 2 is a schematic cutaway diagram of an exemplary dense fluid plasma applicator using a corona plasma treatment. The exemplary applicator is a coaxial design comprising an electrically insulating and solid Teflon, PEEK or Delrin applicator body (50). The applicator body (5) is bored to have a central cavity (52) which contains centrally-located and electrically insulated snow tube assembly (54), an electric field generating rind (56) and is ported to affix a propellant injection tee (58). Affixed to the front end (60) of the applicator body (50) is a convergent-divergent mixing nozzle (62) using a threaded connection scheme (not shown). The mixing nozzle (62) is electrically isolated from the electric field generating ring (56) using a suitably sized non-conductive Teflon spacer ring (64). The mixing nuzzle may be non-conductive or conductive and may be wholly or partially, or not, grounded to earth ground via a grounding electrode wire (66) which intimates with the mixing nozzle at an interface (68) between the insulating spacer ring (64) and the mixing nozzle nozzle (62). If the nozzle is metallic or semi-conductive, electric charges will exchange between the grounding electrode wire and the mixing nozzle (62.). Alternatively, the mixing nozzle may be constructed to be semi-conductive with an electrically insulating material housing a metallic conductor (70) at some location along the vertical sections of the cutaway mixing nozzle (62) which is in communication with the electrical grounding wire (66) through an interconnecting conductor wire (72) in communication with the grounding interface (68). Using these design approaches the mixing nozzle can be constructed to 1) 100% un-grounded (all non-conductive), 2) 100% full-grounded (all conductive) or 3) selectively or locally grounded. The semi-conductive design is useful for selectively developing a corona plasma within the propellant stream zone (72) or within the TIG-Snow spray zone. The conductive design is useful for developing a corona plasma within the TIG-Snow spray zone (74) and between the mixing nozzle opening (76) and the substrate (78) being treated. The non-conductive design is useful for developing a corona plasma between the mixing nozzle opening (76) and the substrate (78) being treated. Furthermore, the electric field generating ring (56) is connected (80) to a high voltage conductor wire (82) using a suitable electrically insulating connector (84). The high voltage electrical wire (82) is connected to a high voltage power supply having a positive or negative voltage output of between 1000 and 25000 volts (not shown). The electrical grounding wire (66) may be connected to an earth ground by affixing said grounding wire through a suitable electrically insulated connector (86) and to an earth ground (88). Moreover, the inner snow tube (54) may be selectively grounded via electrical grounding wire (92) through an electrically insulating connector (94) to an earth ground (94). The inner snow tube (54) is constructed from tubular stainless steel and is wrapped in an electrically insulating tubular sheath or body (90), which serves as a dielectric coating. Connecting said snow tube (54) to each ground (94) as discussed above will produce an internal corona field (silent discharge) between (96) the snow tube (54), through the dielectric insulator (90) and the charged electrical field generating ring (56). Increasing or decreasing the distance between the inner snow tube (54) and electric field generating ring increases or decreases the electric field strength. Also increasing or decreasing the horizontal length of the electrical field generating ring (56) and snow tube (54) also increases or decreases the quantity of electrical power that can be applied to the electrical field generating ring (56) from the high voltage power supply (not shown).

The snow tube (54) is fed through an electrical insulating bulkhead fitting (96) and mated with a polymeric (PEEK) snow condensation tube (98) which communicates with the above referenced enhanced snow condensation and modification apparatus (not shown). The condensation tube can be of lengths from generally 12 to 120 inches and is preferably wrapped in a conductor (100) which is electrically grounded through a grounding wire (102) and communicated with an earth ground as shown. Similarly, the propellant delivery tube (104) may have varying lengths and is communicated with the above described propellant delivery and modification apparatus (not shown). The propellant tube (104) is preferably wrapped in a conductor (106) which is electrically grounded through a grounding wire (108) and communicated with an earth ground as shown.

The snow tube (54) optionally contains one or more conductive needle (110) which are located at the end of the snow tube (54) as shown and are sandwiched between the snow tube (54) and dielectric coating (90) as shown in the front end partial view. The needles (110) are useful for concentrating electrical field energy and discharging the energy into and between the needles (110) and inner mixing nozzle regions as discussed above or for directing the electric energy, under the influence of the supersonic propellant and snow spray mixture, into and between the needles (110) and substrate (78).

Finally, modified snow (112) is fed through the condensation tube (98) and into the inner conductive snow tube (54). Modified propellant (114) is fed through the propellant delivery tube (104), into the injection tee (58) and into the nozzle cavity (52). The two streams move through each respective coaxial compartment, being selectively and physicochemically modified by the corona electric field depending upon the nature of each stream's modified properties and are mixed within the nozzle mixing throat (116). The modified TIG-Snow stream, comprising reactive species, ozone, snow, abrasives and other modifiers in combination with a corona plasma jet (depending upon the above discussed grounding arrangement) are directed out of the mixing nozzle (76) and toward the substrate (78).

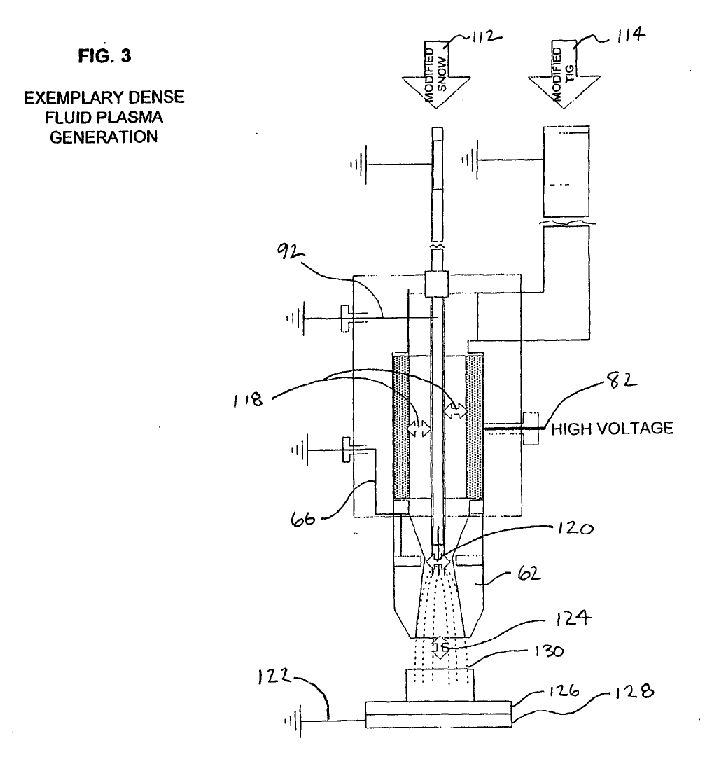

FIG. 3 is a schematic diagram showing the various plasma fields that can be created using the exemplary dense fluid plasma nozzle described in FIG. 2. Connecting the exemplary electrical grounding wire (92) to each ground and energizing high voltage line (82) produces an electric field (118) between the grounded snow tube (54). The presence of an electric field in this region is useful for creating oxidizing radicals from radical forming agents contained in the propellant gas (114) which are then mixed with modified snow (112) within the mixing nozzle (62). Connecting the exemplary electrical grounding wire (66) to earth ground and energizing high voltage line (82) produces an electric field or corona discharge (120) within the mixing nozzle body (62). The presence of an electric field or corona plasma in this region is useful for creating oxidizing radicals from radical forming agents contained in either the propellant gas (114) or snow (112) to produce a mixture of modified TIG-Snow cleaning and modification spray. Finally, connecting the exemplary substrate grounding wire (122) to earth ground and energizing high voltage line (82) produces an electric field or corona discharge (120) within the region (124) between the mixing nozzle body (62) and the substrate (78) being treated. It is preferred that the substrate (78) be placed on top of an electrically insulation layer (126) which is placed onto a grounded conductor (128). The presence of an electric field or corona plasma in this region is useful for creating oxidizing radicals from radical forming agents contained in either the propellant gas (114) or snow (112) to produce a modified TIG-Snow cleaning and modification spray and to directly form oxidizing species on the substrate surface (130) being treated.

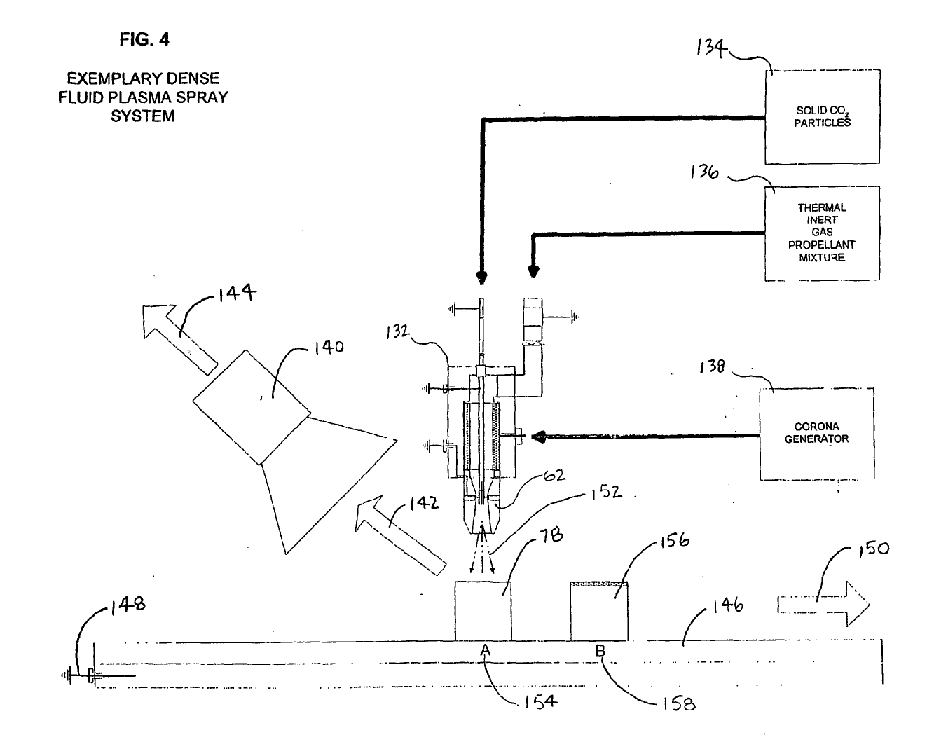

FIG. 4 is a schematic diagram of the exemplary dense fluid plasma spray system with various components described above. The exemplary dense fluid plasma spray system comprises the exemplary dense fluid plasma applicator (132), previously described above using FIG. 2 and FIG. 3. The plasma applicator (132) is connected to supply of modified solid carbon dioxide particles (134) and a supply of modified propellant gas (136). As noted above, both snow particles and propellant gas may be obtained using devices and processes previously invented by the present inventor. An exemplary high voltage power supply (138) for energizing the plasma applicator may be obtained from a number of sources as described above. Having connected the various components to the plasma applicator and grounding the plasma connector to obtain the desired electric field or corona plasma plume as described using FIG. 3, the treatment applicator is ready for operation. The exemplary system also comprises a fume extraction hood (140) which extracts (142) reacted/removed substrate surface contaminants using a vacuum source (144) and transports them to a suitable fume/dust filtration or treatment system (not shown). The exemplary substrate (78) may be placed on a moving conveyor (146) which is suitably grounded (148). The exemplary substrate (78) is moved (150) under the exemplary plasma applicator (132) and specifically under the cleaning and modification spray (152) at a predetermined distance from the mixing nozzle (62) and for a predetermined scan rate and dwell time. Using this scheme, the substrate is first spray treated within a cleaning and modification spray zone (154), following which the treated substrate (156) moves into, for example, a secondary substrate treatment zone (158) which may include adhesive dispensing, potting, painting, dispensing, filling, curing or other sequential operations.

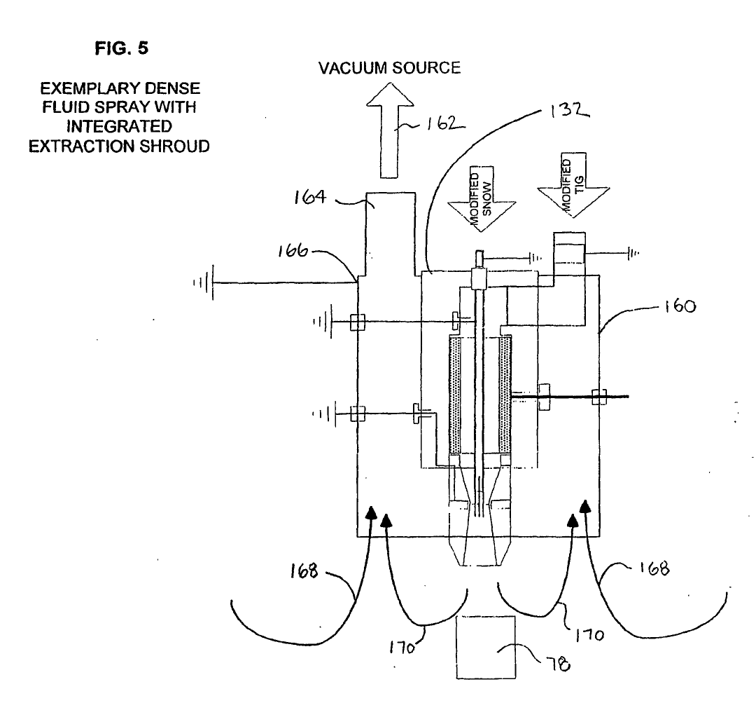

FIG. 5 is a schematic diagram of an exemplary integrated dense fluid plasma spray and fume extraction shroud. This system shows the exemplary plasma applicator (132) with a circular electrically non-conducting shroud (160) surrounding said applicator, which is connected to a vacuum source (162) using a suitable housing connection (164). The exemplary extraction shroud may be further covered with a conductor such as stainless steel which is then grounded (166) to drain away excess electrostatic surface charge accumulating on the extraction hood (160). All necessary grounding elements and snow and propellant feed lines are brought through the extraction shroud as shown. Using the exemplary device, and during cleaning and modification spray operations on the exemplary substrate (78), the surrounding atmosphere (168) and treatment spray with reacted contaminants (170) are drawn up into the shroud under vacuum (162).

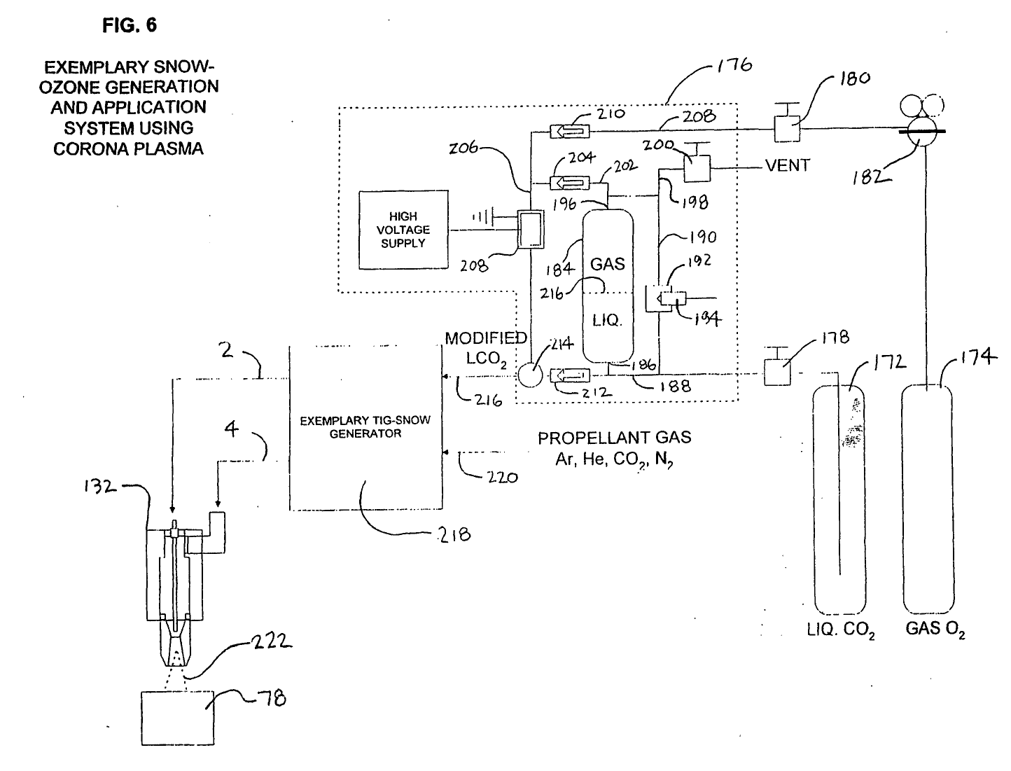

FIG. 6 is a schematic diagram of an exemplary dense fluid-ozone generation and application system using corona plasma. Shown is the figure, a source of liquid carbon dioxide (172) and pressure regulated oxygen gas (174) are connected to a gas-liquid blending and ozonation system (176) using a liquid carbon dioxide feed valve (178), oxygen gas feed valve (180), and oxygen gas pressure regulator (182). The exemplary gas-liquid blending and ozonation system (176) comprises a gas/liquid storage tank (184) which is connected through a bottom hemisphere port (186) to the liquid carbon dioxide feed line (188). The bottom hemisphere port (186) is connected using a connecting pipe (190), and through a tee (192) housing an optical level switch (194), to the upper hemisphere port (196). The upper hemisphere port (196) is further connected to a gas bleed pipe (198) and gas bleed valve (200). The upper hemisphere port (196) is also connected to a gas blending feed pipe (202) and check valve (204) to oxygen-carbon dioxide blending pipe (206). Oxygen gas is fed into the exemplary gas-liquid blending and ozonation system (176) through a feed pipe (208) which is connected to the oxygen-carbon dioxide blending pipe (206) through a check valve (210). The gas blending pipe (206) connects to a corona generator (208) and out through an ozonation feed pipe (210). The ozonated feed pipe (210) connects to liquid carbon dioxide feed pipe (188) via a check valve (212) and using a mixing tee (214).

The exemplary dense fluid blending and ozonation system work as follows, producing a modified liquid carbon dioxide feed stream for use in the present invention. Liquid carbon dioxide is fed through a valve (178) and into the storage tank (184) by a opening bleed valve (200) until the optical sensor (194) determines that the storage tank is filled with liquid carbon dioxide to a predetermined level (216) within the storage tank (184), but below the corona generator system (208). Oxygen gas is fed through feed line (208) by opening valve (180) and regulating the pressure to be equal to the liquid carbon dioxide (172) feed pressure (typically 810-890 psi). Using this scheme, an approximately 50:50 mixture of gaseous carbon dioxide and gaseous oxygen are blended in the blending pipe (206) and into the corona treatment unit (208). Preferably, the entire blending and ozonation system (176) is self-contained and automated. For example, the optical sensor, working in concert with the bleed valve (200), maintains the liquid carbon dioxide level (216) within the storage tank (184) at all times. The corona treatment unit (208) is a novel high pressure AC or DC silent discharge system, described in more detail in a pending patent by the present inventor, which excites oxygen gas molecules contained in the oxygen-carbon dioxide gas mixture to produce an ozone-oxygen-carbon dioxide gas mixture. An electric field applied across a gap through a dielectric and ground metal surface produces a silent discharge. This silent discharge disassociates oxygen gas molecules which recombine as ozone molecules.

The ozonated gas mixture is connected to a tee (214), which is also connected to the liquid carbon dioxide feed pipe (188). This mixture is fed (216) into the exemplary TIG-Snow generator (218), previously described in U.S. Patent '154, along with a supply of propellant gas (220). As described herein, the TIG-Snow generator produces the two component streams; modified snow particles (2) and propellant gas stream (4), which are contactively mixed within the exemplary applicator (132) and directed (222) toward a substrate (78) to be treated.

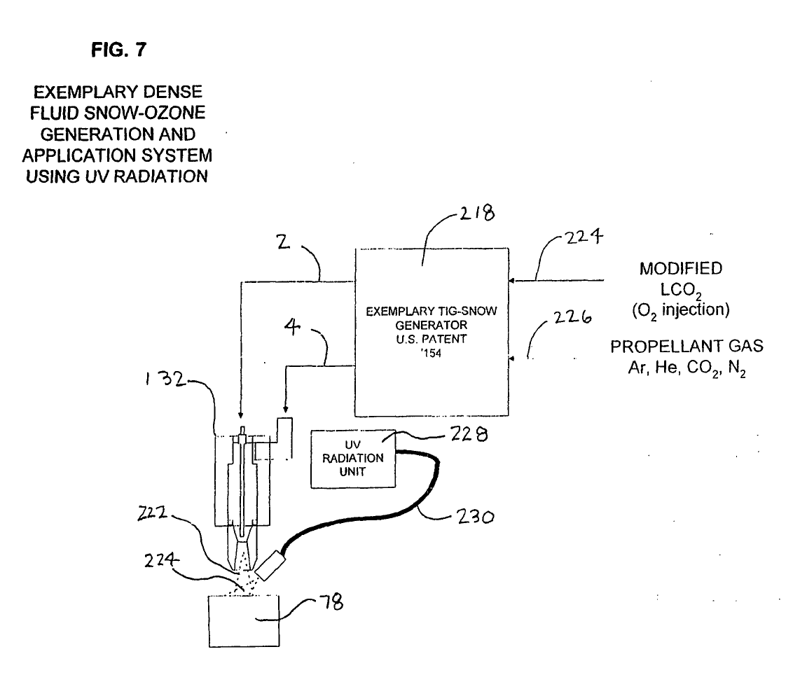

FIG. 7 is a schematic diagram of an alternative exemplary dense fluid-ozone generation and application system using ultraviolet radiation. Shown in the figure, a source of modified liquid carbon dioxide (224) containing oxygen gas and a supply of pressure regulated propellant gas (226), as previously described above using FIG. 6, are connected to the exemplary TIG-Snow generator (218), previously described in U.S. Patent '154. The modified liquid carbon dioxide has not been treated using a corona plasma generator as in FIG. 6 above as it is treated using ultraviolet radiation at the substrate (78) to produce the necessary ozone component. As described herein, the TIG-Snow generator produces the two component streams; modified snow particles (2) and propellant gas stream (4), which are contactively mixed within the exemplary applicator (132) and directed (222) toward a substrate (78) to be treated. In this embodiment, ultraviolet radiation is produced using a conventional UV curing system (228) and UV light delivery pipe (230) with output in the 100 to 400 nm spectrum. Oxygen contained in the TIG-Snow spray stream (222) absorbs radiation at a wavelength of 189.9 nm in transit and at the substrate-spray interface (224) as shown to produce a mixture of ozone-snow-propellant. The usefulness of this approach is that the UV curing device can be used for adhesive curing in subsequent bonding operations following surface treatment using the present invention.

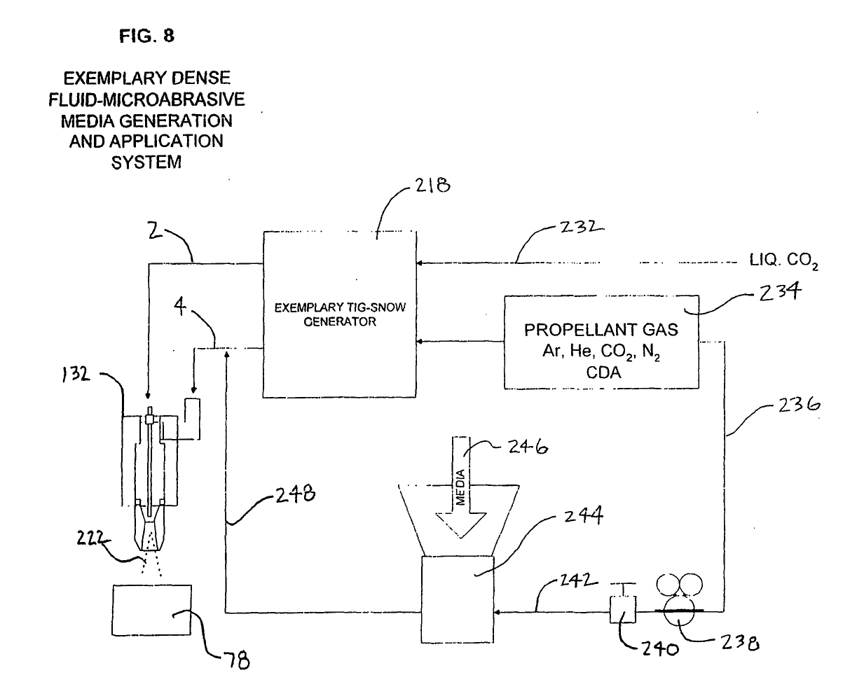

FIG. 8 is a schematic diagram of the exemplary dense fluid-microabrasive generation and application system. Shown in the figure, a source of modified liquid carbon dioxide (224) containing one or more additives and a supply of pressure regulated propellant gas (234), are connected to the exemplary TIG-Snow generator (218), previously described in U.S. Patent '154. As described herein, the TIG-Snow generator produces the two component streams; modified snow particles (2) and propellant gas stream (4), which are contactively mixed within the exemplary applicator (132). In this embodiment, microabrasive particles are added to a second propellant gas pipe (236), derived from the same or different gas supply source. The second propellant pipe (236) is pressure regulated using a suitable gas regulator (238) and feed valve (240) which is fed (242) into a abrasive particle injector (244). Micro abrasive media particles (246) such as silica, sodium carbonate, walnut shells and conductive plastics are fed into the second propellant stream and the mixture of propellant and particles is fed (248) into the first propellant stream (4). The resulting mixture of modified snow particles and modified propellant gas containing abrasive particles is sprayed (222) at the exemplary substrate (78) to be treated. The usefulness of this embodiment is derived as follows. The abrasive particle feed may be selectively turned on and off to allow the TIG-Snow spray mixture to remove ablated surface contamination and residual abrasive particles. Moreover, the TIG-Snow spray may be used to either cool or heat a substrate surface contamination prior to microabrasive treatment to aid to hardening or softening, respectively, the surface contamination.

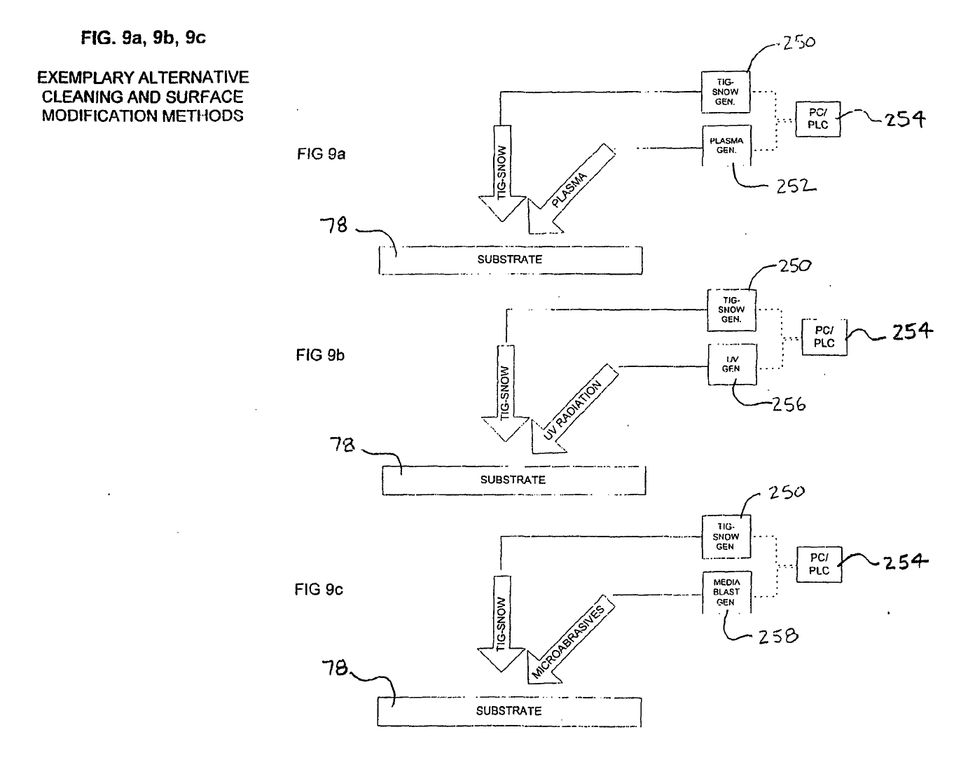

FIGS. 9a, 9b, and 9c schematically represent various methods to combine conventional, but heretofore, independent surface cleaning and surface modification technologies into much more useful cleaning and surface modification tools. Although presented separately, these methods may be further combined into one of more method combinations to clean and prepare a substrate surface for bonding operations.

FIG. 9a is a schematic diagram of the exemplary alternative dense fluid surface cleaning and modification method using a conventional corona plasma treatment device in combination with a dense fluid spray. As shown in the figure, the exemplary substrate (78) may be cleaned and modified sequentially or in combination, in accordance with the novel processes, methods and apparatus described herein, using a conventional snow spray or pellet CO₂ spray cleaning device (250), available from Deflex Corporation, Valencia, Calif., with a surface plasma treatment device (252), available from Tri-Star Technologies, El Segundo, Calif. Using this approach, the method of applying modified TIG-Snow spray streams in combination with a corona plasma surface treatment may be accomplished. A PC/PLC control system and software (254) may be used to automate the operation of both systems, as well as provide automation of a substrate conveyance system (not shown).

FIG. 9b is a schematic diagram of the exemplary alternative dense fluid surface cleaning and modification using a conventional pulsed ultraviolet curing device in combination with a dense fluid spray. As shown in the figure, the exemplary substrate (78) may be cleaned and modified sequentially or in combination, in accordance with the novel processes, methods and apparatus described herein, using a conventional snow spray or pellet CO₂ spray cleaning device (250), available from Deflex Corporation, Valencia, Calif., with an ultraviolet curing device (256), available from Xenon Corporation, Woburn, Mass. Using this approach, the method of applying modified TIG-Snow spray streams in combination with a ultraviolet radiation treatment may be accomplished. A PC/PLC control system and software (254) may be used to automate the operation of both systems, as well as provide automation of a substrate conveyance system (not shown).

FIG. 9c is a schematic diagram of the exemplary alternative dense fluid surface cleaning and modification using conventional microabrasive surface treatment device in combination with a dense fluid spray. As shown in the figure, the exemplary substrate (78) may be cleaned and modified sequentially, in accordance with the novel processes, methods and apparatus described herein, using a conventional snow spray or pellet CO₂ spray cleaning device (250), available from Deflex Corporation, Valencia, Calif., with a microabrasive blast treatment device (258), available from Comco Systems, Burbank, Calif. Using this approach, the method of applying modified TIG-Snow spray streams in combination with a microabrasive surface treatment may be accomplished in a sequential manner. A PC/PLC control system and software (254) may be used to automate the operation of both systems, as well as provide automation of a substrate conveyance system (not shown).

Although the invention has been disclosed in terms of preferred embodiments, it will be understood that numerous variations and modifications could be made thereto without departing from the scope of the invention as set forth herein.

1. A method for cleaning a substrate surface comprising simultaneously:
selectively removing one or more unwanted surface contaminants from the substrate surface;
exposing a native clean surface layer of the substrate surface; and
modifying the substrate surface with energetic radicals and radiation.
